(19) United States
(12) Patent Application Publication
(10) Pub. No.: US 2022/0379943 A1
(43) Pub. Date: Dec. 1, 2022

(54) SHOPPING CART WITH DROP DOWN FRONT GATE

(71) Applicant: MATTHEW O. FODNESS, Port Charlotte, FL (US)

(72) Inventor: MATTHEW O. FODNESS, Port Charlotte, FL (US)

(21) Appl. No.: 17/333,205

(22) Filed: May 28, 2021

(51) Int. Cl. B62B 3/18; B62B 5/00

(52) U.S. Cl. CPC B62B 3/182; B62B 5/0009

(57) ABSTRACT

A shopping cart (1) having a forward rotating front gate (2) to allow a user to unload contents of a shopping cart from the front without having to reach over sides of a shopping cart, thereby avoiding potential back injuries. Side bumpers (4) prevent the front gate from rotating inward and holding tabs (6) on top of the front gate fit securely into slots (7) on the shopping cart to hold the front gate in a closed position while shopping.

### BACKGROUND OF THE INVENTION

Conventional shopping carts may be made of metal or hard plastic and generally have four fixed sides arranged rectangularly and having a floor mounted on wheels. Shoppers places food and merchandise into the cart as they shop. Then when it comes time to check out and pay, shoppers must reach over the sides of the shopping cart and lift the contents for placement on the conveyor belt. After paying for the contents, the removal process repeats itself when the shopper has to remove the contents from the shopping cart into their vehicle for the trip home.

Unfortunately, bending over the sides of a shopping cart to remove the contents can result in severe back injuries, especially if the merchandise is heavy. Such injuries can result in considerable pain and a lengthy recovery period.

Another problem with conventional shopping carts is that the size of an item it can hold is limited by the dimensions of the four sides of the shopping cart. If an item is longer than the length of the cart there is no way to expand the cart to hold the item.

Thus, a need exists for a shopping cart that deters the occurrence of back injuries and size limitations associated with conventional shopping carts.

Past attempts to resolve this problem include the following references, but none disclose a front gate having the same structure as the present invention:

| Patent/App. No. | Inventor | Issue/Pub. Date |
|---|---|---|
| 3,036,722 | Sharaway | May 29, 1962 |
| 3,443,665 | Zschaeck | May 13, 1969 |
| 3,645,554 | Von Stein | Feb. 29, 1972 |
| 5,385,358 | Adamson | Jan. 31, 1995 |
| 5,899,285 | Curbelo | May 4, 1999 |
| 6,193,246 | Ondrasik | Feb. 27, 2001 |
| US2010/0066043 | Tyrrell | Mar. 18, 2010 |
| 10,618,540 | Bacallao | Apr. 14, 2020 |

### SUMMARY OF THE INVENTION

This invention relates to shopping carts and more particularly to a shopping cart having an openable drop down front gate for easy removal of shopping cart contents. The primary object of the present invention is to provide a shopping cart that decreases the likelihood of back injuries caused by a shopper having to reach down over the sides of a shopping cart to remove the contents thereof.

Another object of the present invention is to provide such a shopping cart of which the lengthwise capacity may be expanded to accommodate items exceeding a length of the sides of the shopping cart.

The present invention fulfills the above and other objects by providing a shopping cart having a contents holding section with a bottom, two sides, a back and a front side mounted on wheels and a gate on a front side having a top, two sides and a bottom wherein the bottom is attached to the front side of the shopping cart in a by circular hinges or other means to allow the gate to be opened downward from the shopping cart or to be removeably detachable. One or more tabs on the top of the sides of the front gate fit into slots on the shopping cart to securely retain the front gate in a closed position while shopping. A hand-hold slot proximate the top of the front gate provides for easier rotation of the front gate by the user. At least one elongated bumper on a front of the shopping cart prevents the front gate from moving backward.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of the shopping cart of the present invention with the front gate in a closed position;

FIG. 2 is a perspective view of the shopping cart of the present invention with the front gate in an open position;

FIG. 3 is a front view of the shopping cart of the present invention with the front gate in an open position;

FIG. 4 is a perspective view of the shopping cart of the present invention without the front gate; and

FIG. 5 is a front view of the front gate of the shopping cart of the present invention.

### DESCRIPTION OF THE PREFERRED EMBODIMENTS

For purposes of describing the preferred embodiment, the terminology used in reference to the numbered items in the drawings is as follows:

1. shopping cart, generally

2. front gate

3. hand slot

4. side bumpers

5. round hinges

6. holding tabs

7. slots for holding tabs

8. front bottom of cart

9. oval holding slot

10. front gate sides

11. front gate top

12. front gate bottom

13. front gate bottom

14. sides

15. back

16. bottom

17. wheels

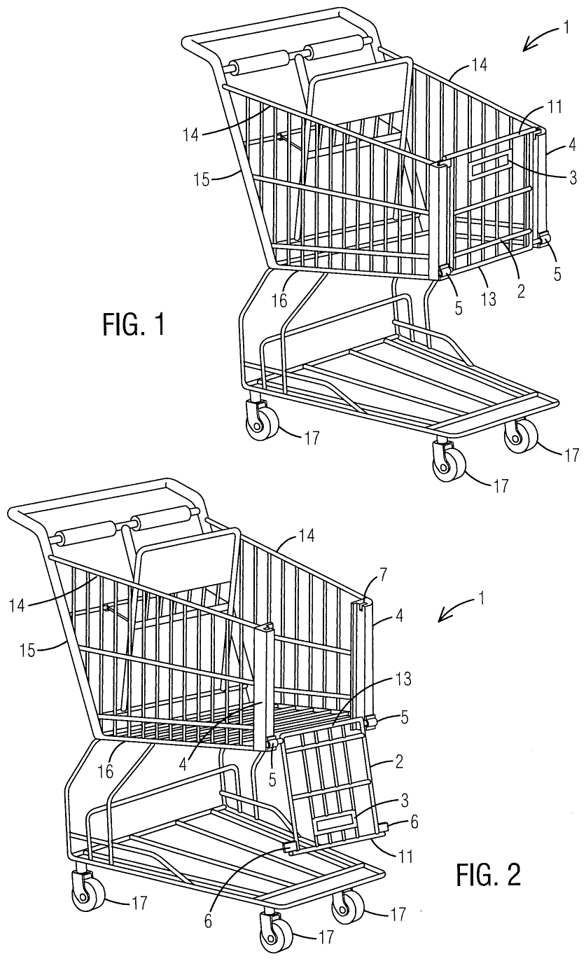

Referring now to the drawing figures, FIGS. 1, a perspective view of a shopping cart 1 with a front gate 2 of the present is illustrated. Like conventional shopping carts the shopping cart 1 of the present invention has a back 15, two sides 14, a bottom 16, a front 2 forming a holding area 13, all of which is mounted on wheels 17. However, unlike conventional shopping carts, the front of the shopping cart 1 of the present invention is a gate 2 which is attached to a front of the shopping cart by rotatable means that allow the front gate 2 to be opened downward and outward when it is pulled open by inserting one's hands in the hand aperture 3. The rotating means may be hinges 5, a spindle on the front gate 2 in a slot and so forth. Bumper guards 4 on each side of the shopping cart 1 may be provided to keep the front gate 2 from rotating inward.

FIG. 2 is a perspective view of the shopping cart 1 of the present invention with the front gate 2 in an open position. In addition to the components of the invention previously described in relation to FIG. 1, FIG. 2 illustrates the holding tabs 6 on top of each side of the front gate 2 which are designed to fit into slots 7 when the front gate 2 is closed in order to prevent the front gate 2 from inadvertently opening while shopping.

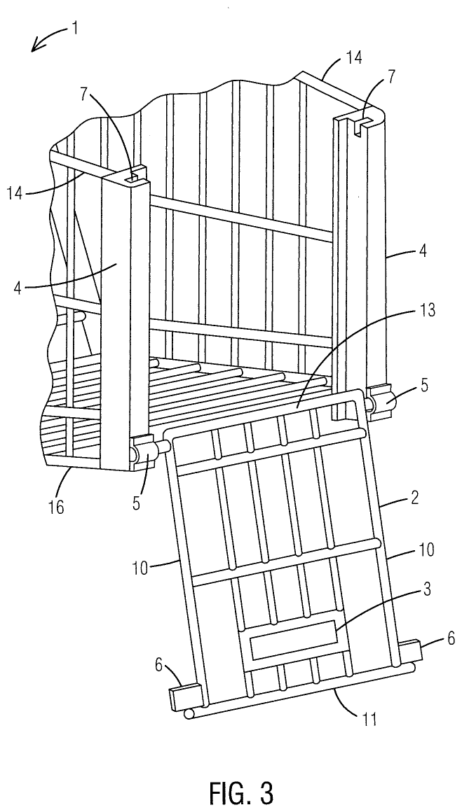

FIG. 3 is a front view of the shopping cart 1 of the present invention illustrating the front gate 2 in the open position. In this view the hand hold aperture 3 proximate the top of the front gate 2 and the holding tabs 6 on both sides at the top of the front gate 2 are shown. Additionally, rotating means consisting of round hinges 5 on both sides 14 of the shopping cart 1 attach the front gate 2 to the shopping cart 1 and allow the front gate 2 to rotate outward when a user pulls upward on the front gate when closed and to rotate upward so the tabs 6 fit securely into the slots 7 when rotated to a closed position. The bumpers 4 on each side 14 act to prevent the front gate 2 from rotating backward into the contents holding section 13.

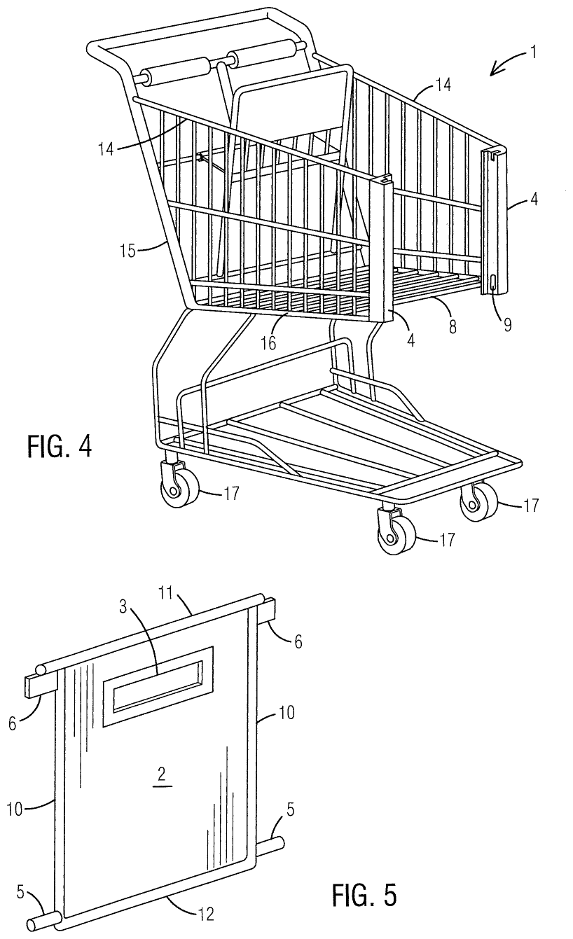

FIGS. 4 and 5 are a perspective view of a shopping cart 1 of the present invention with the front gate 1 removed and a front gate 2 by itself as it might appear when made of plastic. The only differences in the shopping cart 2 and the front gate 2 when made of plastic is that the shopping cart 2 would not need a hinges 5 as shown and described previously, but rather an elongated oval slot 9 on each side near a bottom of the shopping cart 1 into which a round tab 5 would fit. Thus, when the front gate 1 is closed and lifted upward by using the hand hold 3 so as to release the holding tabs 6 from the slots 7 the front gate 2 can be rotated downward.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. A shopping cart having a contents holding section with a bottom, two sides, a back and a front side mounted on wheels further comprising:
a gate on a front side having a top, two sides and a bottom wherein the bottom is attached to the front side of the shopping cart by hinges to allow the gate to be opened downward from the shopping cart.

2. The shopping cart of claim 1 wherein the gate further comprises a hand-hold slot proximate the top of the front gate.

3. The shopping cart of claim 1 gate further comprising:
tabs on the top of the sides of the front gate; and
slots on a top front of each side of the shopping cart wherein the tabs fit in the slots when the front gate is closed to securely retain the front gate in a closed position.

4. The shopping cart of claim 1 further comprising:
at least one elongated bumper on a front of the shopping cart to prevent the front gate from moving backward.

5. A shopping cart having a contents holding section with a bottom, two sides, a back and a front side mounted on wheels further comprising:
a gate on a front side having a top, two sides and a bottom wherein the bottom is attached to the front side of the shopping cart by hinges to allow the gate to be opened downward from the shopping cart;
wherein the gate further comprises a hand-hold slot proximate the top of the front gate;
tabs on the top of the sides of the front gate;
slots on a top front of each side of the shopping cart wherein the tabs fit in the slots when the front gate is closed to securely retain the front gate in a closed position;
at least one elongated bumper on a front of the shopping cart to prevent the front gate from moving backward.
